(19) United States
(12) Patent Application Publication
(10) Pub. No.: US 2006/0026466 A1
(43) Pub. Date: Feb. 2, 2006

(54) Support methodology for diagnostic patterns

(75) Inventors: Steven Pozarycki, Morris Plains, NJ (US); Douglas Drechsel, Livingston, NJ (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 10/909,664

(22) Filed: Aug. 2, 2004

(51) Int. Cl. G06F 11/00

(52) U.S. Cl. 714/38

(57) ABSTRACT

A method of providing diagnostic patterns for customer support, comprising identifying a recurring problem type, obtaining a diagnostic pattern to diagnose the recurring problem type where a solution of the recurring problem type is converted into a series of one or more steps taken in solving the recurring problem type, making available the diagnostic pattern to support engineers and customers based upon a generic problem presented, receiving feedback about the effectiveness of the diagnostic pattern and modifying the diagnostic pattern according to the feedback.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The present disclosure relates generally to providing defined investigative techniques in software troubleshooting and problem diagnosing. More particularly, the present disclosure employs the methodology of design patterns, applying it to customer support systems in order to achieve more efficient troubleshooting and problem resolving techniques.

### BACKGROUND

Customer support systems have become an integral part of many of today's high technology companies. Online customer support is being provided by various websites and live connections to experts connected via phone or web is common, if not the standard, in current business. A problem with many of such systems is their inefficiency. This stems from the granularity of the solution methods currently implemented by most companies. Generally, support is very meticulous, customers must themselves specifically figure out exactly what the problem is in order to find the exact solution. Thus, a typical customer support system has an extensive database of specific problem types and a search must be conducted within the database to find the precise match to the problem presented. This form of customer support is inefficient for multiple reasons. For example, customers must first know the exact problem that is occurring, before being able to receive a clear solution or guidance on solving it. Another problem is that customers must also be able to link their problem specifically to the one stored in the database by correctly naming and classifying it, identically to the way it is placed in the database.

An alternative is connecting customers to live customer support representatives via the phone or some other means of communication and to have such representatives troubleshoot and resolve the problem presented. This is also inefficient in that many recurring problems get resolved anew every time, and often in many different ways, leading to inconsistent messages to end-customers, instead of a well-defined and thought out solution process. This alternative can also be costly, difficult and time consuming, depending on the support representative assigned to the case.

Design patterns have long been used in software construction and other engineering fields. Design patterns are proven solutions to recurring problems in a specific context. However, they have generally been implemented by software coders, designers and engineers, not the general user or support provider.

A new method is desirable, one which would receive a general description of the customer's problem or symptom and then guide the customer through an investigative process leading ultimately to the solution of the problem or at least to a fairly exact diagnosis of it. The present disclosure employs the methodology of design patterns, applying it to customer support systems in order to achieve more efficient troubleshooting and problem resolving techniques.

### BRIEF DESCRIPTION OF THE DRAWINGS

FIG. 1 is a flow diagram of an exemplary way diagnostic patterns can be created and maintained by a support organization, in accordance to certain embodiments of the invention.

FIG. 2 is an illustration of the use of internal and external websites for providing of diagnostic patterns, in accordance to certain embodiments of the invention.

FIG. 3 is a flow diagram illustration of the support methodology for diagnostic patterns being applied to a customer inquiry within a support organization, in accordance to certain embodiments of the invention.

FIG. 4 illustrates the deployment of the support methodology for diagnostic patterns in accordance to certain embodiments of the invention.

FIG. 5 is a flow diagram illustration of an exemplary diagnostic pattern dealing with a generic server core problem, in accordance to certain embodiments of the invention.

FIG. 6 is an illustration of an exemplary interlinking of several diagnostic patterns in order to achieve better problem diagnosing techniques, in accordance to certain embodiments of the invention.

### DETAILED DESCRIPTION

Aspects of the invention are illustrated by way of example and not by way of limitation in the figures of the accompanying drawings in which like references indicate similar elements. It should be noted that references to “an”, “one,” “various” and “certain” embodiments in this disclosure are not necessarily to the same embodiment, and such references mean at least one. In the following description, numerous specific details are set forth to provide a thorough description of the invention. However, it will be apparent to one skilled in the art that the invention may be practiced without these specific details. In other instances, well-known features have not been described in detail so as not to obscure the invention.

The present disclosure includes a support methodology of design patterns being applied to customer support systems. For the purposes of this disclosure, these design patterns are called diagnostic patterns. Diagnostic patterns provide a way to develop, document and distribute known and well defined investigative techniques from a support organization to the customer or support engineer, thereby improving case time to resolution, customer satisfaction and general consistency across various problem solutions. This methodology impacts all facets of a support organization including, but not restricted to, frontline customer support, end customers, high value support offerings and customer help desks.

In one embodiment of the invention, the methodology can be a collection of diagnostic patterns, which are a type of investigative techniques, they can provide a customer or a support engineer with various documented avenues of investigation to help the customer or support engineer diagnose the specific problem they are having and to ultimately solve it. The term “support engineer,” for the purposes of this disclosure, can mean any person employed by a support organization, who deals with helping customers in resolving problems, including but not limited to customer service representatives, technicians, system administrators and other technology experts. A “customer,” on the other hand, means any person or entity who is using the product supported by the support organization (e.g., end-customers, software development companies and other product users). Diagnostic patterns can be associated with or linked to other diagnostic patterns, and they can be traversed in various ways, usually according to the input of the customer or support engineer. The diagnostic patterns can be represented in a number of ways, including but not limited to a data structure such as a binary tree or an acyclic graph. These data structures can be accessed by various algorithms presently known in the art in order to retrieve any such diagnostic pattern.

The following embodiments illustrate the functionality of the methodology through the use of websites. However, such website implementation is not necessary for the purposes of this invention. Many other systems of user interface can be utilized including, but not limited to, databases, books, training videos, software programs, and other forms of providing information.

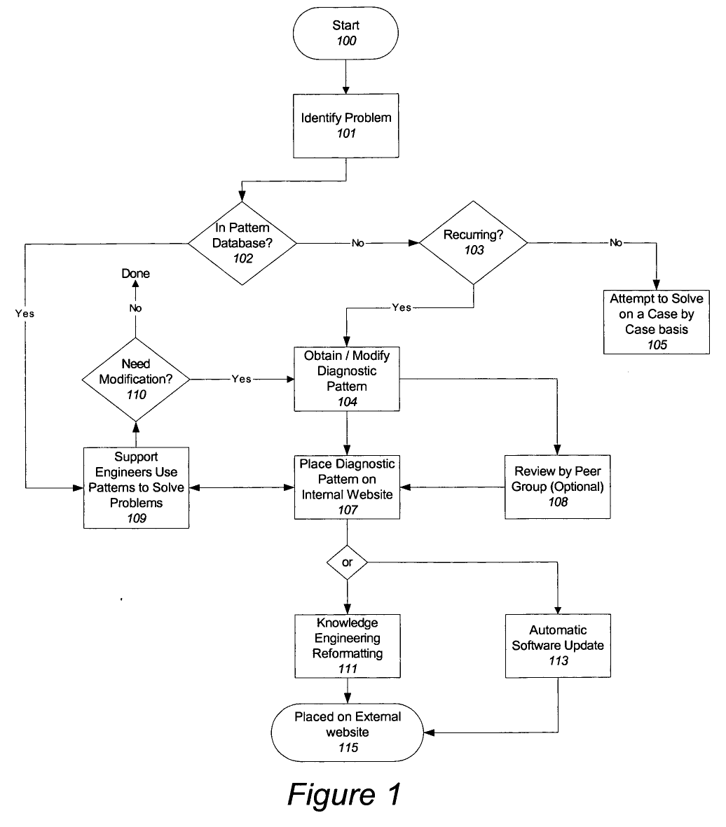

FIG. 1 is a flow diagram illustration of diagnostic pattern creation and modification, in accordance to various embodiments of the invention. Although this figure depicts functional steps in a particular order for purposes of illustration, the process is not necessarily limited to any particular order or arrangement of steps. One skilled in the art will appreciate that the various steps portrayed in this figure can be omitted, rearranged, performed in parallel, combined and/or adapted in various ways.

In step 101, a problem is identified, usually by receiving such a problem from customer input. In step 102, the database of diagnostic patterns can be searched in order to find a diagnostic pattern which corresponds to the problem identified in step 101. If a diagnostic pattern already exists for this problem, it can be forwarded to a support engineer who can subsequently use the diagnostic pattern in order to attempt to diagnose and solve the problem presented, as further discussed in step 109. In step 103, if no corresponding diagnostic pattern is found, the problem can be evaluated to determine whether it should be identified as “recurring.” A recurring problem can be a problem which has occurred more than a certain specified number of times. In one embodiment, a recurring problem can be defined as any problem which has occurred more than once. Recurring problems can be identified in a number of ways, for example a support engineer may simply recognize that a particular problem at bar, has been presented and addressed previously. Of course this is not the only way to identify problems which are recurring. Automated means such as analyzing customer requests, automated queries, data mining past cases, generated reports and other software programs and statistical analyses, as are well known in the art, can also be used. In step 105, if the problem is not identified as recurring it can be resolved by a customer support representative on a case by case basis.

In step 104, once a problem has been identified as recurring, the problem can be assigned to a support engineer, who diagnoses or resolves the problem and subsequently creates a diagnostic pattern documenting the solution process to be followed. In step 110, if there is already a pattern created for the particular problem at bar, the support engineer can update it, modify it or link it to other diagnostic patterns in order to help resolve the problem.

In various embodiments, to achieve maximum efficiency, the recurring problems can be assigned to support engineers which are best equipped to deal with the specific problem presented, i.e. engineers who are highly specialized experts in that particular field. As an example, recurring problems dealing with core server issues such as generic server hangs, timeouts, thread management and core dump issues can be assigned to one support expert, while recurring problems dealing with security issues such as security socket layer (SSL) matters, domain trust and domain intercommunication problems can be assigned to another support expert, one best equipped to deal with that area of technology. This type of allocation and distribution of recurring problems can achieve a very efficient and consistent resolution across a wide spectrum of similar problems and can also cut the time to resolution of each newly assigned recurring problem.

In step 108, the diagnostic pattern can optionally be sent to a group of peers of other support engineers, who may review the pattern and include any of their own opinions, modify the diagnostic pattern or link it to other patterns which the peers may deem relevant to the problem. Such peer review can help insure that the diagnostic pattern includes optimal strategies for resolving the particular problem deemed to be recurring.

In step 107, the diagnostic pattern can be made available to support engineers, employees and other persons who have internal access to the support organization. In various embodiments this can be done by placing the diagnostic pattern on the internal website of the support organization. Placement can be automated, for example, once a diagnostic pattern has been created and stored in a database, a Java Server Page (JSP) may also update the internal website to reflect this new modification of the database. Many other ways of updating are possible including, but not limited to, manual updating by a system administrator, active server pages (ASPs), various scripts, managed hosting services and other web production and design tools.

In step 109, frontline support engineers or other persons having access to the internal website, as mentioned above, can use the internal website to access various diagnostic patterns. Frontline support engineers, for purposes of this disclosure, can be support engineers who first attempt to resolve the customer's problem(s). For example, a frontline support engineer, working on a problem received from a customer, can have a specific protocol to follow. The support engineer may first search the database of available diagnostic patterns that deal with the general problem presented by a customer. In one embodiment a keyword search of the database, as is known in the art, can be implemented. The diagnostic pattern may require the frontline engineer to follow some specific procedure to explore various avenues of possible errors in the program. The diagnostic pattern can be interlinked with other diagnostic patterns, and the frontline support engineer could explore these patterns as well. While using the diagnostic pattern, the engineer may discover that it does not sufficiently solve the problem or that other means of resolution are necessary. The frontline support engineer can then send the problem to a backline support engineer to update or modify the pattern accordingly, as illustrated in step 104, and to replace the diagnostic pattern on the internal website or create a new diagnostic pattern on the site, as illustrated in steps 107 and 108. The term “backline support engineer,” as used here, can mean some kind of a senior engineer, highly specialized technician, supervisor, overseer or a support engineer that may otherwise have better access to problem solutions than the frontline engineer who did not resolve the problem. Thus, problems which are unresolved by frontline engineers can be sent to backline support engineers who are more experienced and who can update and modify various diagnostic patterns.

In step 111, a team of knowledge engineers can work with the support engineer who created or modified the diagnostic pattern in order to reformat it for general customer use and ease of understanding. Knowledge engineers can specialize in preparing and repackaging the diagnostic patterns for external consumption. This can include many things such as making the pattern easy to use, linking it more extensively to other diagnostic patterns and generally creating a more in-depth procedure which would guide a customer through the process of diagnosing and resolving a problem in front of him. However, this whole step of knowledge engineering the diagnostic pattern is not necessary and can be skipped. As illustrated in step 113, the process of updating the external website or generally making the diagnostic pattern ready for external use can be automated as described in step 107. For example, the external website can be linked to an internal website and various programs, as are known in the art, may automatically update the external website therefrom. Alternatively the external site could be connected to a database and various programs could similarly update the site to reflect the information in the database. Many similar techniques can be implemented by one skilled in the art.

In step 115, the diagnostic pattern can be made available to external consumers as a tool for troubleshooting and debugging problems in their software. Customers can subsequently access and follow the diagnostic patterns provided, in order to diagnose their specific problem and to obtain a solution to it. It is contemplated that diagnostic patterns may not provide an absolute solution every single time. However, even if the customer is unable to resolve the problem himself, he will be better prepared to interface with support engineers and that in itself could expedite time taken for the entire process of the customer support system. The advantage of this methodology is the improved time to resolution of many problems, case deflection, customer satisfaction and education and decreased workload for support engineers and consequently decreased costs to the support organization. Thus even a small increase in customer self-resolution of problems is an important benefit obtained in terms of costs and customer satisfaction.

Note that throughout the illustrated process in FIG. 1, the problems which have not been identified as recurring can be dealt with in various ways such as sending them through to general support engineers who can resolve them, or by other various customer support systems known in the art. They can be kept in a database, in order to retrieve those problems that are frequent, and which later may need to be identified as recurring.

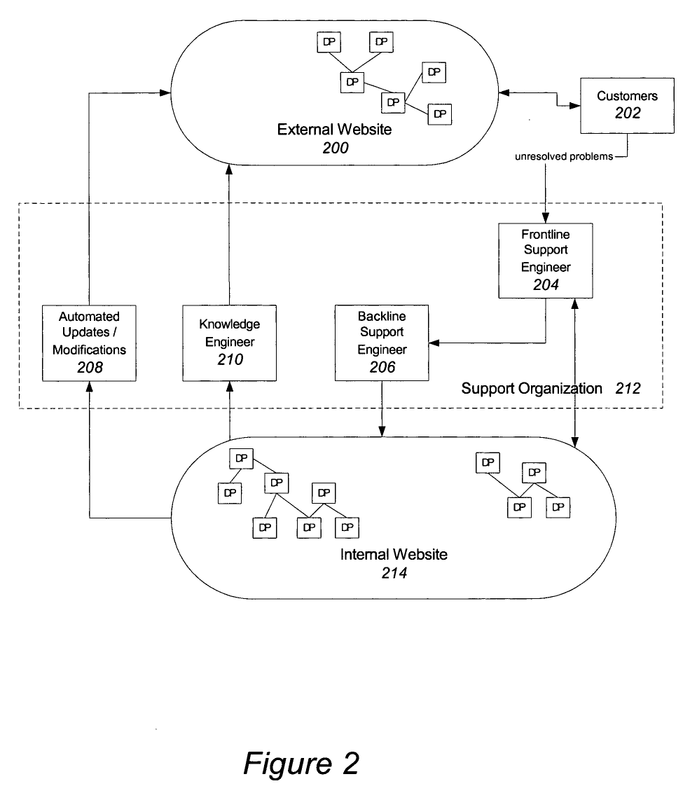

FIG. 2 is an exemplary diagram of an external and an internal website for providing diagnostic patterns can be maintained by a support organization, in accordance to various embodiments of the invention. Although this figure depicts components as logically separate, such depiction is merely for illustrative purposes. It will be apparent to those skilled in the art that the components portrayed in this figure can be combined, rearranged or divided into various subcomponents. Furthermore, steps in this diagram can be omitted, rearranged, performed in parallel and/or adapted in various ways.

An external website 200 can be maintained by a support organization 212. Such an external website can provide diagnostic patterns to various customers 202. As customers access the external site, they utilize the diagnostic patterns DP contained therein and follow the procedures described in the diagnostic patterns thereby attempting to diagnose and resolve their problems.

Once a customer runs across a problem which cannot be resolved by a diagnostic pattern, he or she can contact the frontline support engineer 204 in the support organization for help. The frontline engineers, can then use their own experience in problem solving as well as diagnostic patterns contained in the internal website 214 of the support organization in order to attempt resolving the problem presented to them by the customer. Whether or not the frontline support engineer is able to solve the problem, it can be forwarded to the backline engineer 206 who can use extensive experience in resolving the problem. During this process, the backline engineer can mark the problem as recurring and update the internal website 214 of the support organization to contain a new or a newly modified diagnostic pattern. In various embodiments, this new diagnostic pattern can subsequently be linked to older existing diagnostic patterns in order to best allow for future similar problem resolution.

The internal website can be accessed by knowledge engineering personnel 210 in order to retrieve newly created and modified diagnostic patterns, reformat them for external consumption and place them on the external website. During this reformatting the diagnostic pattern can be optimized for performance, ease of use and understanding and also be linked to other diagnostic patterns on the external website.

In various embodiments, the knowledge personnel step can also be disposed of entirely. Automated forms of revision and updates 208 can be implemented in order to reflect the changes in the internal website. As previously discussed, a JSP is merely one example of transmitting the modifications in the internal website to the external consumption site. Other automated forms of updating information could also be implemented, as are well known in the art.

Although in the embodiment illustrated above only a backline support engineer can update the internal website of the support organization, it should be noted that this access could also be given to frontline support engineers, customer service representatives, and other persons associated with the organization, in order to allow for maximum efficiency of problem resolution.

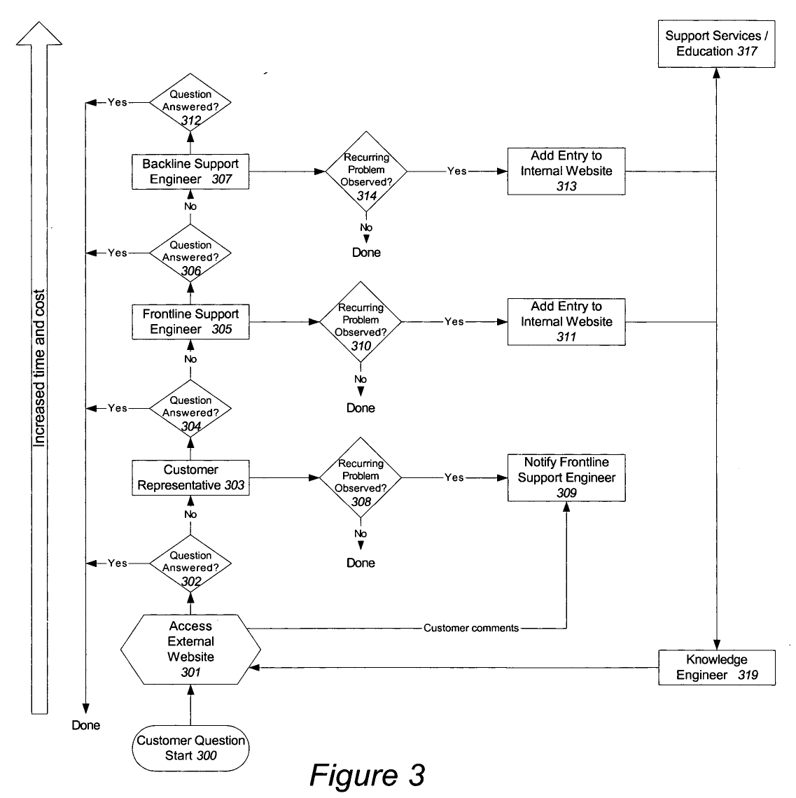

FIG. 3 is a flow diagram illustration of the support methodology for diagnostic patterns being applied to a customer inquiry within a support organization, in accordance to various embodiments of the invention. Although this figure depicts functional steps in a particular order for purposes of illustration, the process is not necessarily limited to any particular order or arrangement of steps. One skilled in the art will appreciate that the various steps portrayed in this figure can be omitted, rearranged, performed in parallel, combined and/or adapted in various ways.

In one embodiment, various customers access the external website 301 of the support organization, obtaining the troubleshooting diagnostic pattern information contained therein. They may be given the option to place comments on the site, or to notify the support organization of any sort of recurring problems they have themselves observed while troubleshooting the products of the support organization. Customer-observed recurring problems and other general comments can be forwarded to the frontline support engineer 309 who can then evaluate the problem, create or modify a diagnostic pattern and place (or update) the pattern on the internal website of the company.

In various embodiments, customer inquiries which are not resolved by the diagnostic patterns 302 on the external website can be forwarded up the chain of customer support system. For example, in step 303, customer service representatives take initial inquiries of the customers and attempt to resolve them. In step 304, if the customer service representatives cannot come to a resolution, they can forward the inquiry to the frontline support engineer 305, as well as notify the frontline engineer 309 of a recurring problem that the customer service representative may have observed 308. For example, the representative may note that this inquiry is a type of recurring problem that many customers are having, and therefore he may recommend that the frontline engineer create a diagnostic pattern for this type of problem and place it on the internal website 311 of the support organization. On the other hand a support organization need not provide customer service representatives at all, the first customer inquiries could simply be addressed by frontline support engineers.

In various embodiments, the frontline support engineer can reevaluate the inquiry and make his own attempts at resolving the issue. During this process, he may observe a recurring problem 310 which may need to be addressed by a diagnostic pattern. The frontline engineer can create a diagnostic pattern, placing the corresponding entry on the internal website 311 of the support organization. Alternatively, this type of access to modify the internal website need not necessarily be granted to the frontline engineer, it may, for the purposes of efficiency, be restricted to backline engineers. If the frontline engineer does not come to a resolution of the customer's inquiry 306 he can then forward the inquiry further, to the backline support engineer 307. By applying extensive experience, the backline support engineer can resolve the customer's inquiry 312 and in the process create or modify any diagnostic pattern observed 314, as previously discussed. The backline engineer can subsequently add the newly created or modified diagnostic pattern to the internal website 313 in order to best deal with similar inquiries in the future. It should be noted that, as a customer inquiry moves up the chain of the support organization, the time and cost for the resolution of that inquiry can increase, so it is preferable to resolve most inquiries at the entering level of the external website.

Continuing the example, throughout the entire process, knowledge engineers 319 can access the internal website of the company, reformat and repackage various diagnostic patterns for external use and subsequently make those patterns available on the external website, for customer access. This updating process can also be automated via the use of various software programs and other means, as already discussed. Various support training services and education 317 to employees and customers can also be provided, using the diagnostic patterns maintained on the internal or external website of the support organization.

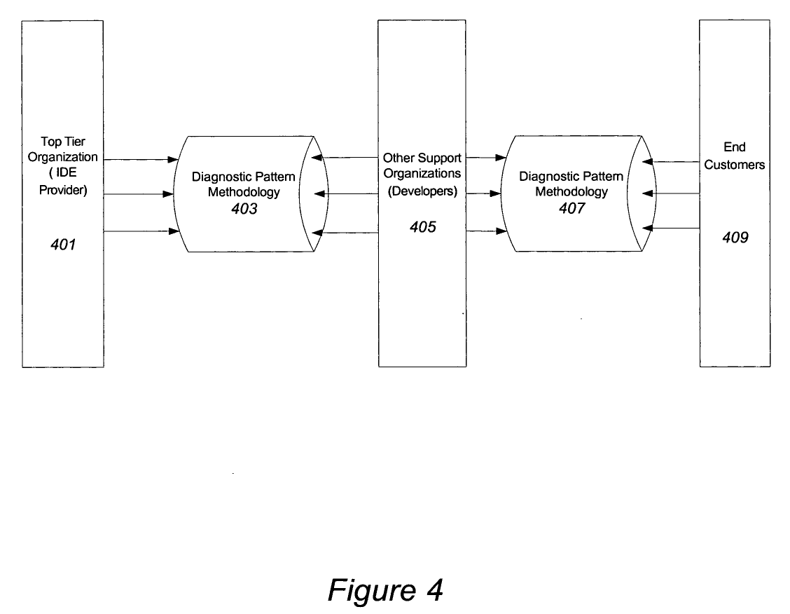

FIG. 4 is an illustration of an exemplary deployment of the support methodology for diagnostic patterns, in accordance to various embodiments of the invention. Although this diagram depicts components as logically separate, such depiction is merely for illustrative purposes. It will be apparent to those skilled in the art that the components portrayed in this figure can be combined or divided into other more or less elements accordingly.

In various embodiments, support organizations can be multi-tiered. As an example, a top tier corporation 401, such as BEA Systems, providing interactive development environments (IDEs), may employ the support methodology 403 in order to provide diagnostic patterns to other software development companies 405 which, in turn, use the IDEs in order to develop their own products and services and provide it to end customers. Similarly those software development companies 405 may use the support methodology for diagnostic patterns 407 to provide support to the end customers 409.

Identical support methodologies need not be implemented by the various support organizations which have need for them. Different companies can customize the support methodology according to their own needs and requirements.

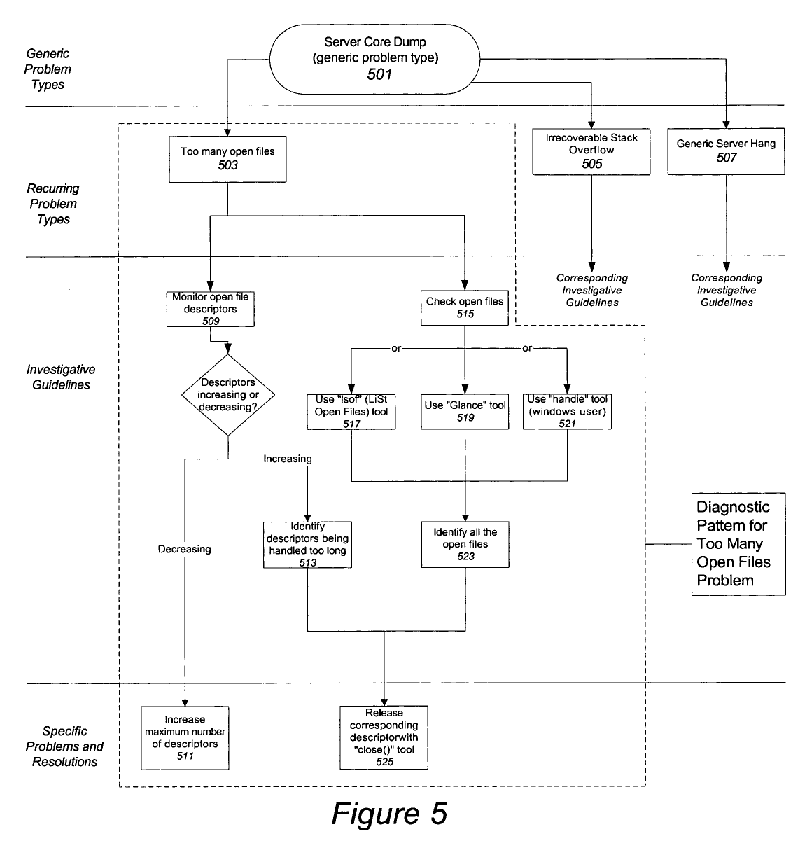

FIG. 5 is an exemplary support diagnostic pattern dealing with a generic problem of a server core dump, in accordance to various embodiments of the invention. It should be noted that this diagnostic pattern is not intended to be complete, exhaustive or self-sufficient nor guarantee a resolution to any particular type of problem. The pattern is presented here purely for purposes of illustration, as to a sample structure and flow of the methodology used in such patterns. Similarly, not every diagnostic pattern needs to be structured the same way, many problems encompass multiple sub-problems which may require their own resolutions and their own investigative guidelines.

The customer can be guided by the generic problem type that is occurring. For example, a server may core dump 501, meaning shut down unexpectedly, hang, terminate, or otherwise crash in some manner. This is a type of a generic problem because the customer is not able to find the specific error which caused the core dump. A server may crash for various reasons, some of which are illustrated by the recurring problem types. As one example, this may occur because too many files are left open at one time 503. This type of problem may have previously been identified as recurring because either some support engineer noticed its frequent occurrence or this has been data-mined from past cases that have come before the support organization.

The “too many open files” diagnostic pattern can be defined by the investigative guidelines as follows. A customer can be advised to first try to monitor the file descriptors 509 in order to identify if the total amount of file descriptors is too low or if some file descriptors are not correctly being released. This can be diagnosed by checking at different periods the total number of file descriptors to determine whether or not this number decreases or keeps increasing. If the number is decreasing, the customer could be advised to increase the maximum number of file descriptors 511 to prevent the problem from re-occurring. If the number is increasing, on the other hand, the customer could be told to release the corresponding file descriptors by using the Unix operating system “close( )” command.

Otherwise the customer could be advised to check all open files 515. Multiple tools can be provided by the diagnostic pattern depending on the operating system that the customer is using such as the Unix “lsof” (List Open Files) 517, “glance” 519, or the Microsoft Windows “handle” 521 commands. Any of these methods would allow the user to identify the specific files which are being left open 523. Consequently, the customer could resolve his problem by releasing the file descriptors 525 which correspond to the files left open.

The generic problem of server core can of course have other causes or symptoms for its occurrence, including but not limited to irrecoverable stack overflow 505 and generic server hangs 507. These recurring problem types can have their own investigative guidelines accordingly. Similarly, recurring problem types such as generic server hang can be associated with other recurring problem types in order to allow for better customer guidance to resolution of their problems.

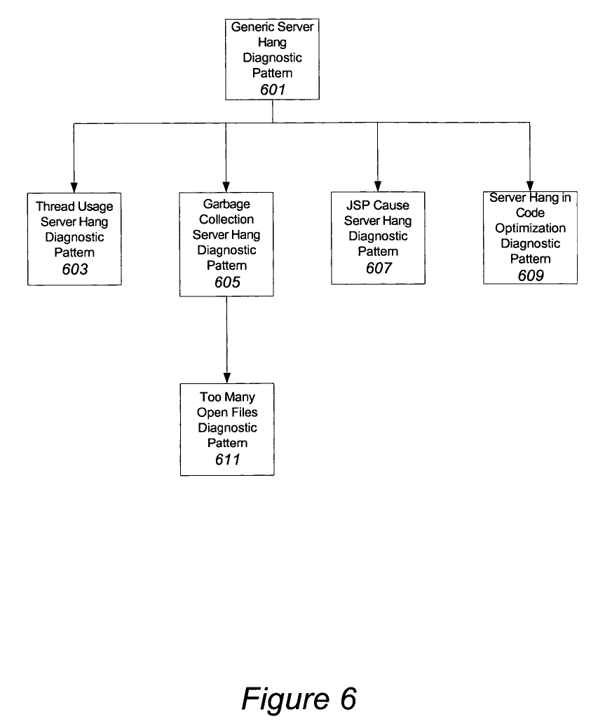

FIG. 6 is an illustration of several exemplary diagnostic patterns interlinked with one another in order to provide better problem resolution and diagnosis. Although this diagram depicts components as logically separate, such depiction is merely for illustrative purposes. It will be apparent to those skilled in the art that the components portrayed in this figure can be combined into one diagnostic pattern or subdivided into multiple diagnostic patterns.

In various embodiments, the generic server hang recurring problem can have a diagnostic pattern associated with it 601. This diagnostic pattern can further be linked to other diagnostic patterns, which are associated to recurring problems which may be the cause of the generic server hang problem. As an example, the recurring problem of thread usage server hang 603 may show the symptom of the generic server hang. Therefore it could be helpful to include a link to the diagnostic pattern for the thread usage problem in the diagnostic pattern for the generic server hang. This can be implemented by providing the customer with various avenues of investigation, one or more of which leads to the diagnosis of the problem with thread usage. Once the customer determines that thread usage is the problem he is having, he can then utilize the thread usage server hang diagnostic pattern 603, in an attempt to come to a resolution. Similarly, other diagnostic patterns could be interlinked with the generic server hang pattern, such as garbage collection diagnostic pattern 605, JSP cause server hang diagnostic pattern 607, and server hang in code optimization diagnostic pattern 609. By that same token, any of these diagnostic patterns sub-linked with the generic server hang pattern, can be linked to other diagnostic patterns, e.g. the too many open files diagnostic pattern 611. The present example is not intended to be an actual and complete way of correctly linking various diagnostic patterns. It is presented here for purposes of illustration only, so as to show the capability of interlinking several diagnostic patterns together. The support engineers can determine which diagnostic patterns should actually be interlinked.

Various embodiments may be implemented using a conventional general purpose or specialized digital computer(s) and/or processor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits and/or by interconnecting an appropriate network of conventional component circuits, as will be readily apparent to those skilled in the art.

The foregoing description of the preferred embodiments of the present invention has been provided for purposes of illustration and description. It is not intended to be exhaustive or to limit the invention to the precise forms disclosed. Many modifications and variations will be apparent to the practitioner skilled in the art. Embodiments were chosen and described in order to best explain the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A method of providing diagnostic patterns, the method comprising:
identifying a recurring problem type;
obtaining a diagnostic pattern to diagnose the recurring problem type wherein the diagnostic pattern includes a solution of the recurring problem type and wherein the solution can be converted into a series of one or more steps taken in solving the recurring problem type;
providing the diagnostic pattern to at least one of: a customer and a support engineer, wherein the providing is based upon a generic problem presented by the support engineer or the customer;
receiving feedback concerning effectiveness of the diagnostic pattern from at least one of: the customer and the support engineer; and
modifying the diagnostic pattern based on the feedback.

2. The method of claim 1 wherein the step of identifying the recurring problem type comprises:
receiving a problem description from at least one of: a customer and a support engineer.

3. The method of claim 1 wherein:
the recurring problem type is identified by the one or more support engineers;

4. The method of claim 1 wherein:
the recurring problem type is identified by data mining problems previously presented by one or more customers.

5. The method of claim 1 wherein:
the diagnostic pattern is made available to customers via the use of an external website.

6. The method of claim 1 wherein:
the diagnostic pattern is made available to support engineers via the use of an internal website.

7. The method of claim 1, further comprising:
reviewing the obtained diagnostic pattern by one or more support engineers before making it available.

8. The method of claim 1, further comprising:
reformatting the diagnostic pattern for external use by knowledge engineering, before making available the diagnostic pattern to the one or more customers.

9. The method of claim 1, further comprising:
interlinking the diagnostic pattern with a second diagnostic pattern based on the recurring problem type.

10. The method of claim 1 wherein:
the diagnostic pattern is obtained from one of: a highly specialized technician and a support engineer.

11. The method of claim 1 wherein:
the feedback is received from customers who have used the diagnostic pattern.

12. A method of providing diagnostic patterns, the method comprising:
identifying a recurring problem type;
obtaining a diagnostic pattern to diagnose the recurring problem type wherein the diagnostic pattern includes a series of one or more steps for diagnosing the recurring problem type;
receiving a generic problem from one or more customers;
making the diagnostic pattern available to the one or more customers through an external user interface;
making the diagnostic pattern available to one or more support engineers through an internal user interface;
receiving feedback about effectiveness of the diagnostic pattern; and
modifying the diagnostic pattern according to the feedback received.

13. The method of claim 12, further comprising:
interlinking the diagnostic pattern with a second diagnostic pattern based on the recurring problem type.

14. The method of claim 12, further comprising:
reviewing the obtained diagnostic pattern by one or more peer support engineers before making it available.

15. The method of claim 12 wherein:
the external interface is an external website.

16. The method of claim 12 wherein:
the internal interface is an internal website.

17. The method of claim 12, further comprising:
reformatting the diagnostic pattern for external use.

18. The method of claim 12, wherein:
the feedback is received from customers that have used the diagnostic pattern.

19. The method of claim 12 wherein:
the diagnostic pattern is obtained from one of: a highly specialized technician and a support engineer.

20. The method of claim 12 wherein:
the recurring problem type is identified by the one or more support engineers;

21. The method of claim 12 wherein:
the recurring problem type is identified through data mining.

22. A method for providing diagnostic patterns, the method comprising:
receiving a problem description from one or more customers;
directing the problem description to a first support engineer wherein the first support engineer attempts to diagnose the problem description;
directing the problem description to a second support engineer wherein the second support engineer attempts to diagnose the problem description if the problem description was not diagnosed by the first support engineer;
determining whether the problem description is a recurring problem type;
obtaining a diagnostic pattern for the recurring problem type wherein a series of one or more steps can be documented for diagnosing the recurring problem type;
making available the diagnostic pattern to one or more of: a customer and a support engineer;
receiving feedback concerning the effectiveness of the diagnostic pattern; and
modifying the diagnostic pattern based on the feedback.

23. The method of claim 22, further comprising:
interlinking the diagnostic pattern with a second diagnostic pattern based on the recurring problem type.

24. The method of claim 22, further comprising:
reviewing the diagnostic pattern by a group of peer support engineers before making it available.

25. The method of claim 22 wherein:
the diagnostic pattern is made available to the one or more customers on an external website.

26. The method of claim 22 wherein:
the diagnostic pattern is made available to the one or more support engineers on an internal website.

27. The method of claim 22, further comprising:
reformatting the diagnostic pattern for external use.

28. The method of claim 22, wherein:
the feedback is received from customers that have used the diagnostic pattern.

29. The method of claim 22 wherein:
the diagnostic pattern is obtained by employing the backline engineer and wherein the backline engineer is a highly specialized technician.

30. The method of claim 22 wherein:
the recurring problem type is identified by the one or more support engineers;

31. The method of claim 22 wherein:
the recurring problem type is identified by data mining problems previously presented by one or more customers.

32. The method of claim 22 wherein:
the first support engineer is a frontline support engineer; and
wherein the second support engineer is a backline support engineer.

33. A method of providing a diagnostic pattern, the method comprising:
receiving a generic problem type;
making available one or more recurring problem types wherein the recurring problem types are common causes of the generic problem type;
selecting a recurring problem type wherein a one or more of customers and support engineers select the recurring problem type; and
making available investigative guidelines wherein the investigative guidelines lead to one or more of solutions or diagnoses of the recurring problem type; and
wherein the one or more recurring problem types are hierarchically related with the generic problem type.

34. The method of claim 33, further comprising:
receiving feedback from the one or more of customers and support engineers concerning the effectiveness of the investigative guidelines; and
modifying the investigative guidelines according to the feedback received.

35. The method of claim 33 wherein:
the generic problem type is received from the one or more of customers and support engineers.

36. The method of claim 33 wherein:
the one or more recurring problem types are children of the generic problem type; and
the investigative guidelines are children of the one or more recurring problem types.

37. The method of claim 33 wherein:
the feedback is received from the one or more customers that have used the investigative guidelines.
